(19) United States
(12) Patent Application Publication
(10) Pub. No.: US 2024/0184608 A1
(43) Pub. Date: Jun. 6, 2024

(54) CROSS-PLATFORM LIVE MIGRATION USING IMPROVED CPU ERRATA HANDLING

(71) Applicant: VMware LLC, Palo Alto, CA (US)

(72) Inventors: Andrei Warkentin, South Elgin, IL (US); Jared McNeill, Cupertino, CA (US)

(21) Appl. No.: 18/061,298

(22) Filed: Dec. 2, 2022

(51) Int. Cl. G06F 9/455

(52) U.S. Cl. CPC G06F 9/45558; G06F 2009/4557; G06F 2009/45591

(57) ABSTRACT

Techniques for enabling live migration of a VM across host systems that use different CPU platforms of the same ISA (e.g., ARM, RISC-V, etc.) via improved CPU errata handling are provided. In one set of embodiments, these techniques involve paravirtualizing the VM's guest OS to determine the CPU platforms and corresponding microarchitectures of all possible live migration targets (i.e., destination host systems) for the VM. This allows the guest OS to apply/enable appropriate software workarounds for addressing the errata of those various platforms and microarchitectures, which in turn allows the VM to be correctly live migrated to any of the targets.

### BACKGROUND

Unless specifically indicated herein, the approaches described in this section should not be construed as prior art to the claims of the present application and are not admitted to be prior art by inclusion in this section.

An instruction set architecture (ISA) is an abstract model for a computer that defines, among other things, the instructions, data types, registers, and memory behaviors supported by the computer. A microarchitecture is a hardware implementation of an ISA and is realized in the form of a central processing unit (CPU). An integrated circuit (IC) that incorporates a particular set of CPUs, potentially with other system components, is referred to herein as a CPU platform or simply “platform.”

There are a large number of different microarchitectures that implement the ARM ISA developed by Arm Ltd. Examples of such ARM-based microarchitectures include Cortex A53, Neoverse N1, Firestorm, and so on. Some of these ARM-based microarchitectures are designed by Arm itself and licensed to third party vendors. These third party vendors may tweak certain aspects of the licensed microarchitectures and then integrate them into their own (i.e., custom) ARM-based platforms. Other ARM-based microarchitectures are designed from scratch by third party vendors like Apple, Inc. for inclusion in their custom platforms.

One issue with the multitude of ARM-based microarchitectures and ARM-based platforms using these microarchitectures is that the live migration of virtual machines (VMs) across the ARM ecosystem is limited to servers (i.e., host systems) which use the same platform. This is partly because the manner in which existing guest operating systems (OSs) implement software workarounds for CPU errata (i.e., bugs) prevents cross-platform live migration.

### BRIEF DESCRIPTION OF THE DRAWINGS

FIG. 1 depicts an example environment.

FIG. 2 depicts a CPU errata handling workflow.

FIG. 3 depicts a version of the environment of FIG. 1 that implements improved CPU errata handling according to certain embodiments.

FIG. 4 depicts an improved CPU errata handling workflow according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to techniques for enabling live migration of a VM across host systems that use different CPU platforms of the same ISA (e.g., ARM, RISC-V, etc.) via improved CPU errata handling. As known in the art, live migration is a virtualization feature that allows a running VM to be moved from one host system to another without power cycling the VM.

At a high level, these techniques involve paravirtualizing the VM's guest OS to determine the CPU platforms and corresponding microarchitectures of all possible live migration targets (i.e., destination host systems) for the VM. This allows the guest OS to apply/enable appropriate software workarounds for addressing the errata of those various platforms and microarchitectures, which in turn allows the VM to be correctly live migrated to any of the targets.

### 1. Example Environment and Solution Overview

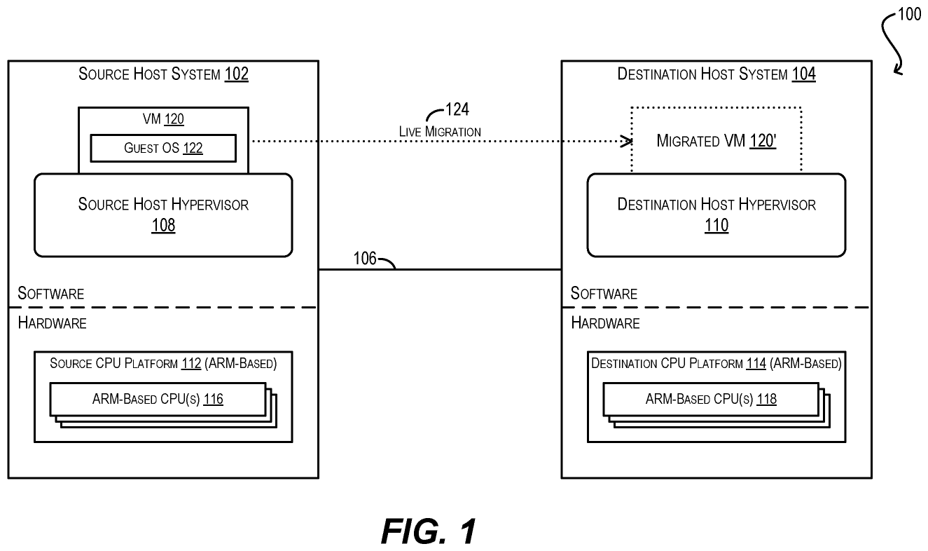

FIG. 1 depicts an example environment 100 in which embodiments of the present disclosure may be implemented. As shown, environment 100 includes a first (source) host system 102 that is communicatively connected with a second (destination) host system 104 via a network link 106. In one set of embodiments, host systems 102 and 104 may be part of a host cluster comprising a group of interconnected host systems, such as a host cluster in an enterprise or cloud computing deployment.

Each host system 102/104 includes, in software, a hypervisor 108/110 (i.e., source hypervisor 108 and destination hypervisor 110 respectively) that provides an execution environment for running one or more VMs. In addition, each host system 102/104 includes, in hardware, an ARM-based CPU platform 112/114 (i.e., source CPU platform 112 and destination CPU platform 114 respectively) comprising a set of CPUs 116/118 that implement an ARM-based microarchitecture (i.e., ARM-based CPUs).

For purposes of this disclosure, it is assumed that source CPU platform 112 is different from destination CPU platform 114. For example, CPUs 116 of source CPU platform 112 and CPUs 118 of destination CPU platform 114 may implement different ARM-based microarchitectures (e.g., Cortex A53 vs. Neoverse N1). As another example, CPUs 116 of source CPU platform 112 and CPUs 118 of destination CPU platform 114 may implement different revisions of the same ARM-based microarchitecture (e.g., Cortex A53 revision 4.0 (denoted as “r4p0”) vs. Cortex A53 revision 1.1 (r1p1)). As yet another example, CPUs 116 of source CPU platform 112 and CPUs 118 of destination CPU platform 114 may implement the same revisions of the same ARM-based microarchitecture, but these two CPU platforms may be designed by different vendors and thus may include vendor-specific integration logic and/or features that are not found in the other.

As depicted in FIG. 1, at some point in time a VM 120 running a guest OS 122 may need to be live migrated from source host system 102 to destination host system 104. This live migration process, which is indicated via arrow 124, generally involves copying the memory state of VM 120 from source host system 102 to destination host system 104 over network link 106 while VM 120 continues running. When the majority of VM 120's memory state has been copied over, VM 120 is suspended on the source host side and a new (i.e., migrated) VM 120′ is powered-on on the destination host side. Migrated VM 120′ then resumes execution of the guest workload/operations of original VM 120 on destination host system 104 using the copied memory state.

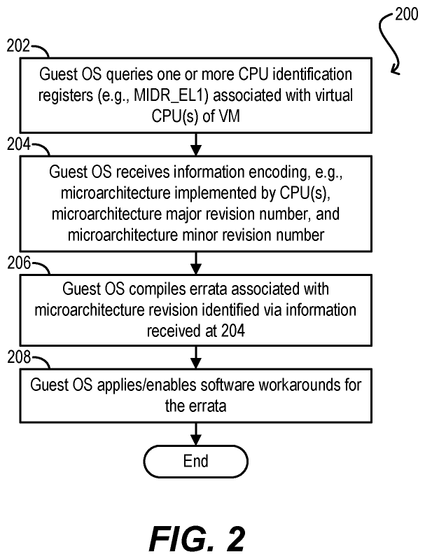

However, due to the way in which existing guest OSs typically perform CPU errata handling, the live migration of VM 120 between host systems 102 and 104—which have different ARM-based CPU platforms as mentioned above—may not be possible. To understand why this is the case, FIG. 2 depicts a conventional CPU errata handling workflow 200 that may be performed by guest OS 122 at the time of power-on/boot up of VM 120 according to certain embodiments.

Starting with step 202, guest OS 122 queries one or more special CPU identification registers (e.g., the MIDR_EL1 register in the ARM ISA) that are associated with the virtual CPU(s) of VM 120, which in turn map to physical CPUs 116 of source CPU platform 112, Note that this step does not involve interacting with source hypervisor 108; guest OS 122 performs this query action independently, without any knowledge that source hypervisor exists (and without any knowledge that VM 120 is a virtual machine rather than a physical machine).

At step 204, guest OS 122 receives from the register(s) information encoding, among other things, (1) the microarchitecture implemented by the CPU(s), (2) the major revision number of the microarchitecture, and (3) the minor revision number of the microarchitecture. For example, assume CPUs 116 are Neoverse N1 r4p0 CPUs. In this scenario, the MIDR_EL1 register can encode the name (or an identifier) for Neoverse N1, the major revision number 4, and the minor revision number 0.

At step 206, guest OS 122 compiles a list of known errata associated with the specific microarchitecture revision identified via the information received at step 204. These errata can include, e.g., major or minor errors that adversely affect the operation of CPUs implementing that microarchitecture revision.

Finally, at step 208, guest OS 122 applies/enables one or more software workarounds to address (e.g., mitigate or fix) the errata, thereby allowing the guest OS and the VM's guest applications to run correctly on CPUs 116 of source CPU platform 112. For example, if one of the errata found at step 206 indicates that a particular CPU functionality F is broken, guest OS 122 may apply/enable a software workaround that prevents F from being used by guest code.

The problems with conventional errata handling workflow 200 in the context of live migrating VM 120 across host systems 102 and 104 are two-fold: first, consider a scenario in which CPUs 116 and 118 of source and destination CPU platforms 112 and 114 implement different ARM-based microarchitectures (or different revisions of the same microarchitecture). In this scenario, because guest OS 122 only applies/enables software workarounds for the errata relevant to the microarchitecture revision implemented by source-side CPUs 116, once VM 120 is live migrated to destination host system 104 it will likely experience errors there due to not having appropriate workarounds in place for the errata relevant to the microarchitecture revision implemented by destination-side CPUs 118.

Second, consider a scenario in which CPUs 116 and 118 of source and destination CPU platforms 112 and 114 implement the same ARM-based microarchitectures with the same revisions, but these platforms are designed by different vendors (and thus include different integration logic, features, etc.). In this scenario, there will likely be platform-level errata for destination CPU platform 114 that are not present in source CPU platform 112, despite that fact that these two platforms use the same microarchitecture revisions. Accordingly, there will be no workarounds present in VM 120 for the platform-level errata of destination CPU platform 114, which will also cause the VM to experience errors once migrated to destination host system 104.

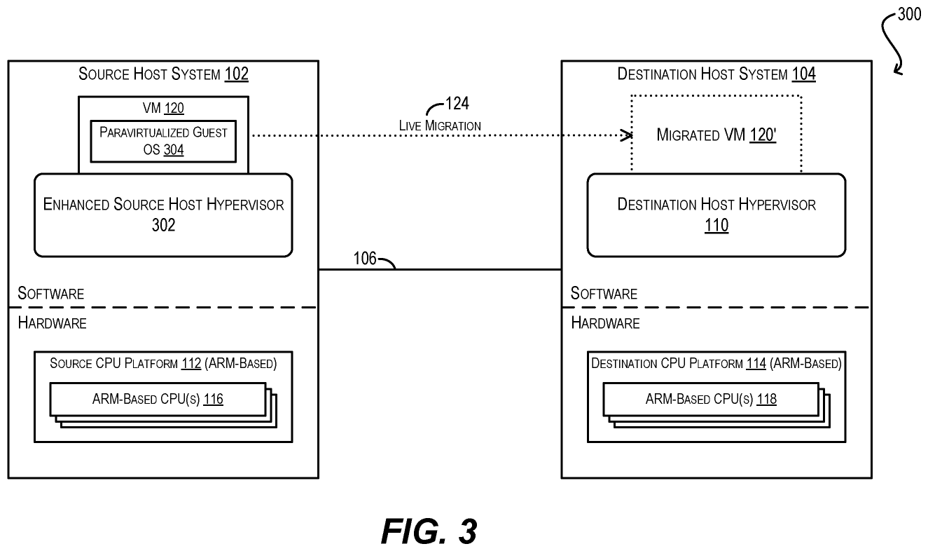

To address the foregoing and other similar problems, FIG. 3 depicts a modified version of environment 100 of FIG. 1 (i.e., environment 300) that includes an enhanced source hypervisor 302 and a paravirtualized guest OS 304 within VM 120 according to certain embodiments. As detailed in section (2) below, at the time of power-on/boot up of VM 120, paravirtualized guest OS 304 can retrieve, from enhanced source hypervisor 302, information regarding the CPU platforms and microarchitectures of all live migration targets of VM 120. As used herein, a “live migration target” of a VM is a host system that the VM can potentially be live migrated to. For example, in one set of embodiments the live migration targets of VM 120 can include destination host system 104 and all other host systems in the same host cluster.

With this information in hand, paravirtualized guest OS 304 can then apply software workarounds to address all of the errata associated with those various CPU platforms and microarchitectures, thereby enabling VM 120 to correctly run on (and thus, be live migrated to) any of the live migration targets. By way of example, assume (A) source CPU platform 112 is a system-on-a-chip (SoC) S1 designed by a vendor VI and includes CPUs implementing an ARM-based microarchitecture M1 (revision r0p0) and (B) destination CPU platform 114 is an SoC S2 designed by a vendor V2 and includes CPUs implemented an ARM-based microarchitecture M2 (revision r1p2). In this case, paravirtualized guest OS of FIG. 3 can identify and apply, within VM 120 at the time of VM power-on/boot up, errata workarounds for SoC S2 and microarchitecture M2 (r1p2), in addition to any errata workarounds needed for SoC Cl and microarchitecture M1 (r0p0). In this way, guest OS 300 can proactively “prepare” VM 120 for running correctly on the CPU platform of destination host system 104 (even though VM 120 is currently running on source host system 102) because destination host system 104 is a live migration target for the VM.

It should be appreciated that FIGS. 1-3 are illustrative and not intended to limit embodiments of the present disclosure. For example, while these figures and the foregoing description assume that source and destination host systems 102 and 104 are ARM-based systems that include different ARM-based CPU platforms, the improved CPU errata handling techniques of the present disclosure may also be used to enable live migration across host systems that include different CPU platforms of another ISA, such as RISC-V or x86. These techniques simply happen to be most useful in the ARM context at the current time because of the large number of disparate ARM-based platforms/microarchitectures from different vendors and the widespread adoption of ARM in enterprise and cloud computing environments.

Further, it should be noted that the improved CPU errata handling techniques of the present disclosure are subject to a couple of caveats. First, while these techniques are a necessary element for enabling cross-platform live migration, they are not sufficient by themselves. For example, different ARM-based platforms may employ different system timer frequencies and/or exhibit other inconsistencies that also prevent cross-platform live migration. Accordingly, all of these issues should be resolved in a comprehensive cross-platform live migration solution.

Second, it may be possible for an errata workaround directed to one CPU platform or microarchitecture to conflict in some way with an errata workaround directed to another CPU platform or microarchitecture. If such a conflict exists between the errata workarounds for e.g., a source host system S and a specific live migration target T, that conflict can be recorded in a migration incompatibility table in order to indicate that live migration is not possible between S and T.

### 2. Improved CPU Errata Handling Workflow

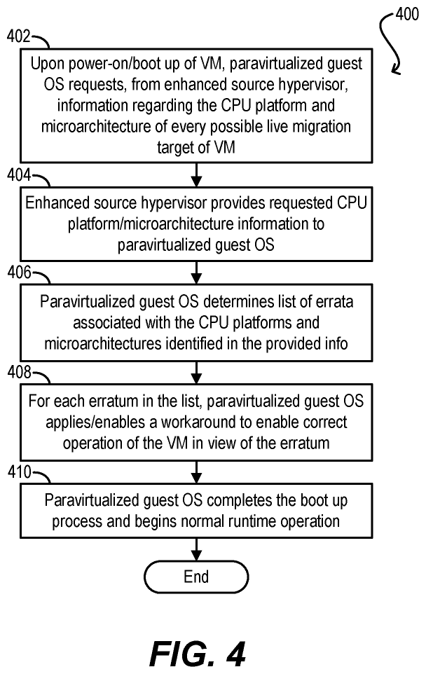

FIG. 4 depicts a workflow 400 that can be executed by enhanced source hypervisor 302 and paravirtualized guest OS 304 of FIG. 3 for performing improved CPU errata handling with respect to VM 120 in accordance with certain embodiments. Workflow 400 assumes that enhanced source hypervisor 302 has exposed a mechanism to paravirtualized guest OS 304 that enables the guest OS to retrieve CPU platform/microarchitecture information regarding the live migration targets of VM 120. For example, in some embodiments enhanced source hypervisor 302 may expose a hypercall (i.e., a software trap from the domain of guest OS 304 to the hypervisor) that provides this information. In other embodiments enhanced source hypervisor 302 may populate one or more virtual firmware tables that are accessible to paravirtualized guest OS 304 with this information.

Starting with step 402, upon power-on/boot up of VM 120, paravirtualized guest OS 304 can request, from enhanced source hypervisor 302, information regarding the CPU platform and microarchitecture of every possible live migration target of the VM. In one set of embodiments this information can include, for each target, a name or identifier (ID) of the vendor (i.e., implementer) of the target's CPU platform, a name or ID of that CPU platform, a name or ID of the vendor of the target's microarchitecture, and revision information (e.g., major and minor revision number) for that microarchitecture.

The specific manner in which paravirtualized guest OS 304 submits the request of step 402 can depend on the mechanism exposed by enhanced source hypervisor 302. For example, if enhanced source hypervisor 302 exposes a hypercall, paravirtualized guest OS 304 can invoke the hypercall. Alternatively, if source hypervisor 302 places this information in one or more virtual firmware tables, paravirtualized guest OS 304 can issue a request to read those tables.

At step 404, enhanced source hypervisor 302 can provide the requested CPU platform/microarchitecture information to paravirtualized guest OS 304. In the case where the live migration targets are ARM-based systems, the provided information can take the form of a list of MIDR_EL1 register values and SoC IDs (one per target). An SoC ID is a set of identifier values that uniquely identify a particular ARM platform/SoC and includes, among other things, an SoC product ID, an SoC revision ID, and an SoC implementer (i.e., vendor) ID. Typically, this SoC ID can be retrieved via an SMCCC call (from privileged firmware) or from the system management BIOS (SMBIOS). For a migration target without a well-defined SoC ID that is otherwise recognized by source enhanced hypervisor 302 via other means, the hypervisor can create a synthetic SoC ID (with the vendor ID field set to the hypervisor vendor) that is assigned to the target's CPU platform and can return this synthetic SoC ID to paravirtualized guest OS 304.

In the case where the live migration targets are systems implementing a different ISA (e.g., RISC-V, x86, etc.), the provided information can take the form of a list of microarchitecture and platform-identifying values that are defined by that ISA.

At step 406, paravirtualized guest OS 304 can determine a list of errata associated with the CPU platforms and microarchitectures identified in the provided information. Paravirtualized guest OS 304 may determine this list via, e.g., one or more databases that map the CPU platforms and microarchitectures with specific errata.

Then, at step 408, paravirtualized guest OS 304 can apply or enable, for each erratum in the list, a software workaround to allow for correct operation of VM 120 in view of that erratum. This step can involve, for example, setting one or more global variables used to control certain OS level operations and/or performing binary patching of the guest OS kernel to mitigate, fix, or avoid the erratum.

Finally, at step 410, paravirtualized guest OS 304 can complete its boot up process and begin normal runtime operation. As mentioned above, a consequence of this improved CPU errata handling workflow is that, at the time VM 120 is migrated to a live migration target that has CPU platform different from source host system 102 (such as, e.g., destination host system 104), all of the appropriate errata workarounds for that destination CPU platform and the microarchitecture of its CPUs will already be in place within the VM. Accordingly, the live migration can be performed successfully (assuming all other non-errata related migration blockers are also handled).

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
requesting, by a guest operating system (OS) of a virtual machine (VM) running on a host system, information from a hypervisor of the host system regarding central processing unit (CPU) platforms and microarchitectures of live migration targets of the VM, each of the live migration targets being another host system to which the VM may be migrated;
upon receiving the information from the hypervisor, determining, by the guest OS, a list of errata associated with the CPU platforms and microarchitectures; and
for each erratum in the list, applying, by the guest OS, a software workaround for enabling correct operation of the VM in view of the erratum.

2. The method of claim 1 wherein the live migration targets of the VM include a destination host system, and
wherein the VM is live migrated from the host system to the destination host system after the applying.

3. The method of claim 1 wherein the requesting, receiving, and applying are performed upon boot up of the VM on the host system.

4. The method of claim 1 wherein the information includes, for each live migration target, a name or identifier of a CPU platform of the live migration target, a name or identifier of a vendor of the CPU platform, a name or identifier of a microarchitecture implemented by CPUs of the CPU platform, and a revision of the microarchitecture.

5. The method of claim 1 wherein the host system and the live migration targets each have a CPU platform that implements a common instruction set architecture (ISA).

6. The method of claim 1 wherein requesting the information comprises invoking a hypercall exposed by the hypervisor to the guest OS.

7. The method of claim 1 wherein requesting the information comprises submitting a request to read one or more virtual firmware tables exposed by the hypervisor to the guest OS.

8. A non-transitory computer readable storage medium having stored thereon instructions executable by guest operating system (OS) running within a virtual machine (VM) of a host system, the instructions embodying a method comprising:
requesting, from a hypervisor of the host system, information regarding central processing unit (CPU) platforms and microarchitectures of live migration targets of the VM, each of the live migration targets being another host system to which the VM may be migrated;
upon receiving the information from the hypervisor, determining a list of errata associated with the CPU platforms and microarchitectures; and
for each erratum in the list, applying a software workaround for enabling correct operation of the VM in view of the erratum.

9. The non-transitory computer readable storage medium of claim 8 wherein the live migration targets of the VM include a destination host system, and
wherein the VM is live migrated from the host system to the destination host system after the applying.

10. The non-transitory computer readable storage medium of claim 8 wherein the requesting, receiving, and applying are performed upon boot up of the VM on the host system.

11. The non-transitory computer readable storage medium of claim 8 wherein the information includes, for each live migration target, a name or identifier of a CPU platform of the live migration target, a name or identifier of a vendor of the CPU platform, a name or identifier of a microarchitecture implemented by CPUs of the CPU platform, and a revision of the microarchitecture.

12. The non-transitory computer readable storage medium of claim 8 wherein the host system and the live migration targets each have a CPU platform that implements a common instruction set architecture (ISA).

13. The non-transitory computer readable storage medium of claim 8 wherein requesting the information comprises invoking a hypercall exposed by the hypervisor to the guest OS.

14. The non-transitory computer readable storage medium of claim 8 wherein requesting the information comprises submitting a request to read one or more virtual firmware tables exposed by the hypervisor to the guest OS.

15. A host system comprising:
a central processing unit (CPU) platform implementing an instruction set architecture (ISA);
a hypervisor;
a virtual machine (VM) running on the hypervisor; and
a non-transitory computer readable medium having stored thereon program code for a guest operating system (OS) of the VM that, when executed by the guest OS, causes the guest OS to:
request, from the hypervisor, information regarding CPU platforms and microarchitectures of live migration targets of the VM, each of the live migration targets being another host system to which the VM may be migrated;
upon receiving the information from the hypervisor, determine a list of errata associated with the CPU platforms and microarchitectures; and
for each erratum in the list, apply a software workaround for enabling correct operation of the VM in view of the erratum.

16. The host system of claim 15 wherein the live migration targets of the VM include a destination host system, and
wherein the VM is live migrated from the host system to the destination host system after the applying.

17. The host system of claim 15 wherein the requesting, receiving, and applying are performed upon boot up of the VM on the host system.

18. The host system of claim 15 wherein the information includes, for each live migration target, a name or identifier of a CPU platform of the live migration target, a name or identifier of a vendor of the CPU platform, a name or identifier of a microarchitecture implemented by CPUs of the CPU platform, and a revision of the microarchitecture.

19. The host system of claim 15 wherein the CPU platforms of the live migration targets also implement the ISA.

20. The host system of claim 15 wherein the program code that causes the guest OS to request the information comprises program code that causes the guest OS to invoke a hypercall exposed by the hypervisor to the guest OS.

21. The host system of claim 15 wherein the program code that causes the guest OS to request the information comprises program code that causes the guest OS to submit a request to read one or more virtual firmware tables exposed by the hypervisor to the guest OS.
